(19) United States
(12) Patent Application Publication
(10) Pub. No.: US 2026/0278020 A1
(43) Pub. Date: Sep. 17, 2026

(54) METHOD AND APPARATUS FOR DETERMINING VEHICLE TRAVELING TRAJECTORY, ELECTRONIC DEVICE AND STORAGE MEDIUM

(71) Applicant: BEIJING HORIZON INFORMATION TECHNOLOGY CO., LTD., Beijing (CN)

(72) Inventors: Bo YAN, Beijing (CN); Liang SONG, Beijing (CN); Degang YANG, Beijing (CN)

(73) Assignee: BEIJING HORIZON INFORMATION TECHNOLOGY CO., LTD., Beijing (CN)

(21) Appl. No.: 19/471,083

(22) PCT Filed: Apr. 9, 2024
(86) PCT No.: PCT/CN2024/086885

§ 371 Date: Sep. 30, 2025

(30) Foreign Application Priority Data
Apr. 23, 2023 (CN) 202310445870.9

(51) Int. Cl. G06F 16/9537; G07C 5/04

(52) U.S. Cl. CPC G06F 16/9537; G07C 5/04

(57) ABSTRACT

The application relates to a method and apparatus for determining a vehicle traveling trajectory, an electronic device and a storage medium. The method comprises: based on historical traveling trajectory information of at least one vehicle on a target road segment, determining a plurality of historical driving-in trajectory points of a driving-in section of the target road segment, and determining a plurality of historical driving-out trajectory points of a driving-out section of the target road segment (S1); determining a driving-in section intersection point of the target road segment based on the plurality of historical driving-in trajectory points, and determining a driving-out section intersection point of the target road segment based on the plurality of historical driving-out trajectory points (S2); and determining a recommended traveling trajectory of the target road segment based on the driving-in section intersection point and the driving-out section intersection point (S3). In this way, a recommended traveling trajectory can be rationally planned for a target road segment, such that it can both reduce the chances of vehicles being unable to drive into the planned path and ensure the operation stability and speed of vehicle.

The present disclosure claims priority to the Chinese patent application number CN202310445870.9 filed on Apr. 23, 2023 with the invention title of “Method and Apparatus for Determining Vehicle Traveling Trajectory, Electronic Device and Storage Medium”, in China National Intellectual Property Administration (CNIPA), which is incorporated herein by reference in its entirety.

### FIELD OF THE PRESENT DISCLOSURE

The present disclosure relates to the technical field of automatic driving, and more particularly relates to a method and apparatus for determining a vehicle traveling trajectory, an electronic device and a storage medium.

### BACKGROUND OF THE PRESENT DISCLOSURE

Currently, a vehicle is controlled to travel at a lane centerline in a planned path according to the planned path in an auxiliary driving mode or an automatic driving mode. When the vehicle needs to be turned or driven into a ramp, if the vehicle travels exactly according to the lane centerline, it may cause the vehicle to miss a rational position for turning or driving into the ramp.

It is an urgent problem to be solved how to rationally determine a vehicle traveling trajectory.

### SUMMARY OF THE PRESENT DISCLOSURE

In order to solve the above technical problem, in an example of the present disclosure there are provided a method and apparatus for determining a vehicle traveling trajectory, an electronic device and a storage medium to rationally perform path planning, such that it can both reduce the chances of vehicles being unable to drive into the planned path and ensure the operation stability and speed of vehicle.

In an aspect of the example of the present disclosure, a method for determining a vehicle traveling trajectory is provided, including:
based on historical traveling trajectory information of at least one vehicle on a target road segment, determining a plurality of historical driving-in trajectory points of a driving-in section of the target road segment, and determining a plurality of historical driving-out trajectory points of a driving-out section of the target road segment;
determining a driving-in section intersection point of the target road segment based on the plurality of historical driving-in trajectory points, and determining a driving-out section intersection point of the target road segment based on the plurality of historical driving-out trajectory points; and
determining a recommended traveling trajectory of the target road segment, based on the driving-in section intersection point and the driving-out section intersection point.

In another aspect of the example of the present disclosure, an apparatus for determining a vehicle traveling trajectory is provided, including:
a driving-in and driving-out trajectory point determination module configured for: based on historical traveling trajectory information of at least one vehicle on a target road segment, determining a plurality of historical driving-in trajectory points of a driving-in section of the target road segment, and extracting a plurality of historical driving-out trajectory points of a driving-out section of the target road segment;
a section intersection point determination module configured for determining a driving-in section intersection point of the target road segment based on the plurality of historical driving-in trajectory points, and determining a driving-out section intersection point of the target road segment based on the plurality of historical driving-out trajectory points; and
a recommended traveling trajectory determination module configured for determining a recommended traveling trajectory of the target road segment based on the driving-in section intersection point and the driving-out section intersection point.

In yet another aspect of the example of the present disclosure, a computer-readable storage medium is provided, having a computer program stored thereon, wherein the computer program is configured for executing the method for determining a vehicle traveling trajectory according to the above first aspect.

In still yet another aspect of the example of the present disclosure, an electronic device is provided, including:
a processor; and
a memory for storing processor-executable instructions;
wherein the processor is configured for reading the executable instructions from the memory and executing the instructions to implement the method for determining a vehicle traveling trajectory according to any one of the aspects described above.

In still yet another aspect of the example of the present disclosure, a computer program product is provided, wherein instructions in the computer program product, when executed by a processor, implement the method for determining a vehicle traveling trajectory provided in any one of the above examples of the present disclosure.

According to the method and apparatus for determining a vehicle traveling trajectory, the electronic device and the storage medium in the examples of the present disclosure, before performing traveling trajectory planning, the historical traveling trajectory information uploaded by the ego vehicle or another vehicle to a specified server after passing through the target road segment may be acquired, the plurality of historical driving-in trajectory points of the driving-in section and the plurality of historical driving-out trajectory points of the driving-out section of the target road segment may be extracted from the historical traveling trajectory information, the driving-in section intersection point of the target road segment may be rationally determined according to the plurality of historical driving-in trajectory points, the driving-out section intersection point of the target road segment may be rationally determined according to the plurality of historical driving-out trajectory points, and then the recommended traveling trajectory passing through the driving-in section intersection point and the driving-out section intersection point may be rationally planned according to the driving-in section intersection point and the driving-out section intersection point of the target road segment, such that it can both reduce the chances of vehicles being unable to drive into the planned path and ensure the operation stability and speed of vehicle.

### BRIEF DESCRIPTION OF THE DRAWINGS

FIG. 1 is a schematic flow diagram of a method for determining a vehicle traveling trajectory in an example of the present disclosure;

FIG. 2 is a schematic diagram of determining a recommended traveling trajectory of a target road segment according to a driving-in section intersection point and a driving-out section intersection point in an example of the present disclosure;

FIG. 3 is a schematic flow diagram of step S2 in an example of the present disclosure;

FIG. 4 is a schematic flow diagram of step S3 in an example of the present disclosure;

FIG. 5 is a schematic flow diagram after step S3 in an example of the present disclosure;

FIG. 6 is a schematic flow diagram of step S7 in an example of the present disclosure;

FIG. 7 is a schematic flow diagram of step S5 in an example of the present disclosure;

FIG. 8 is a schematic diagram of a partial flow of the method for determining a vehicle traveling trajectory in an example of the present disclosure;

FIG. 9 is a schematic flow diagram of step S10 in an example of the present disclosure;

FIG. 10 is a structural block diagram of an apparatus for determining a vehicle traveling trajectory in an example of the present disclosure;

FIG. 11 is a structural block diagram of a section intersection point determination module 200 in an example of the present disclosure;

FIG. 12 is a structural block diagram of a recommended traveling trajectory determination module 300 in an example of the present disclosure;

FIG. 13 is a structural block diagram of the apparatus for determining a vehicle traveling trajectory in another example of the present disclosure;

FIG. 14 is a structural block diagram of a recommended vehicle speed determination module 700 in an example of the present disclosure;

FIG. 15 is a structural block diagram of a reference traveling trajectory determination module 500 in an example of the present disclosure;

FIG. 16 is a structural block diagram of the recommended vehicle speed determination module 700 in another example of the present disclosure; and

FIG. 17 is a structural block diagram of an electronic device in an example of the present disclosure.

### DESCRIPTION OF THE EMBODIMENTS

In order to explain the present disclosure, the illustrative examples of the present disclosure will be described in detail below with reference to the accompanying drawings. It is apparent that the described examples are only some but not all examples of the present disclosure, and it should be understood that the present disclosure is not limited to the illustrative examples.

It should be noted that the relative arrangement of parts and steps, numerical expressions and numerical values set forth in these examples do not limit the scope of the present disclosure, unless otherwise specifically indicated.

### Overview of the Present Application

A vehicle is controlled to travel at a lane centerline in a planned path according to the planned path in an auxiliary driving mode or an automatic driving mode. When the vehicle needs to be turned or driven into a ramp, if the vehicle travels exactly according to the lane centerline, it may cause the vehicle to miss a rational position for turning or driving into the ramp.

Through a great deal of inventive effort, the inventors of the present disclosure have found that when the vehicle needs to be driven into the ramp according to the planned path, if the vehicle is driven into a lane closest to the ramp too early, the operation stability and speed of the ego vehicle may be reduced due to the too early lane change; and if the vehicle is driven into the ramp at a position very close to an entrance of the ramp, there is a possibility that the vehicle cannot be smoothly driven into a lane entrance of a target lane due to an excessive number of vehicles at the entrance. It is an urgent problem to be solved how to rationally perform path planning.

### Illustrative Method

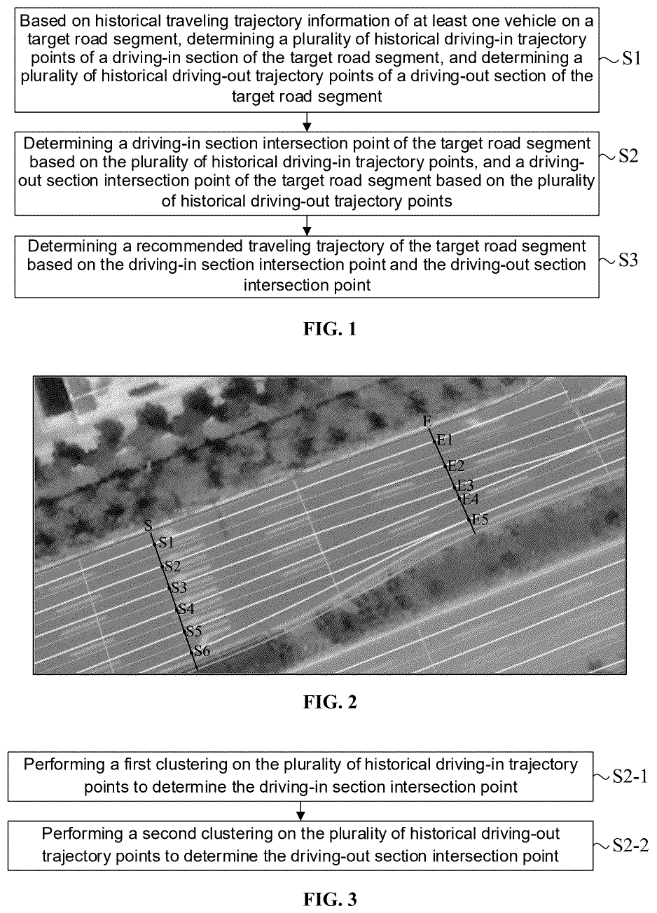

FIG. 1 is a schematic flow diagram of a method for determining a vehicle traveling trajectory in an example of the present disclosure. This example may be applied to an electronic device, and as shown in FIG. 1, the method includes the following steps.

S1: based on historical traveling trajectory information of at least one vehicle on a target road segment, determining a plurality of historical driving-in trajectory points of a driving-in section of the target road segment, and determining a plurality of historical driving-out trajectory points of a driving-out section of the target road segment.

In some optional examples, the target road segment may include: a traveling road segment having a ramp port, a traveling road segment having a lane number change scene, a traveling road segment having a turning scene, a normal traveling road segment, and other types of traveling road segments. The ramp port may include a ramp entrance and/or a ramp exit. The lane number change scene may include a lane increase scene and a lane decrease scene. And the normal traveling road segment may include a single-lane straight traveling road segment and a multi-lane straight traveling road segment.

In some optional examples, during the process of passing through the target road segment at a time, the ego vehicle or another vehicle may collect position information thereof at intervals through a positioning apparatus of the vehicle itself or a positioning apparatus located inside the vehicle (for example, a positioning apparatus of a mobile terminal inside the vehicle) to obtain a plurality of pieces of position information of the vehicle in the target road segment, and a piece of historical traveling trajectory information when the vehicle travels in the target road segment is generated according to the plurality of pieces of position information.

In some optional examples, before performing traveling trajectory planning, the historical traveling trajectory information of the ego vehicle or another vehicle when traveling in the target road segment may be acquired from a specified server. After the ego vehicle or another vehicle passes through the target road segment, the historical traveling trajectory information thereof may be uploaded to the specified server. The specified server may include a server of the Internet of Vehicles, a server of navigation software, and the like.

In some optional examples, during the process of passing through the target road segment at a time, each vehicle may collect position information thereof at intervals through a positioning apparatus of the vehicle itself or a positioning apparatus located inside the vehicle (for example, a positioning apparatus of a mobile terminal inside the vehicle) to obtain a plurality of pieces of position information of the vehicle in the target road segment, and a piece of historical traveling trajectory information when the vehicle travels in the target road segment is generated according to the plurality of pieces of position information.

In some optional examples, for any one of the historical traveling trajectory information acquired from the specified server, one or more trajectory point positions of a driving-in section close to the target road segment may be extracted from the historical traveling trajectory information. For example, if it may be determined that a certain trajectory point is located exactly on the driving-in section of the target road segment according to the historical traveling trajectory information, the trajectory point may be determined as a historical driving-in trajectory point of the historical traveling trajectory information; and if it may be determined that any trajectory point is not located on the driving-in section of the target road segment according to the historical traveling trajectory information, a plurality of trajectory point positions close to the driving-in section of the target road segment may be extracted, a corresponding driving-in trajectory curve of the historical traveling trajectory information is generated based on the plurality of trajectory point positions, and an intersection point between the driving-in trajectory curve and the driving-in section of the target road segment is determined as the historical driving-in trajectory point of the historical traveling trajectory information.

In some optional examples, a historical driving-out trajectory point of any historical traveling trajectory may be determined in the same or similar manner as the historical driving-in trajectory point of any historical traveling trajectory is determined.

In an optional instance, this step S1 may be executed by a processor calling corresponding instructions stored in a memory, and may also be executed by a driving-in and driving-out trajectory point determination module running in the processor.

S2: determining a driving-in section intersection point of the target road segment based on the plurality of historical driving-in trajectory points, and a driving-out section intersection point of the target road segment based on the plurality of historical driving-out trajectory points.

In some optional examples, clustering processing may be performed on the plurality of historical driving-in trajectory points, and the driving-in section intersection point of the target road segment is determined according to a result of the clustering processing. The plurality of historical driving-in trajectory points may also be determined as a plurality of driving-in section intersection points of the target road segment.

The clustering processing may be performed on the plurality of historical driving-out trajectory points, and the driving-out section intersection point of the target road segment is determined according to a result of the clustering processing. The plurality of historical driving-out trajectory points may also be determined as a plurality of driving-in section intersection points of the target road segment.

In an optional instance, this step S2 may be executed by a processor calling corresponding instructions stored in a memory, and may also be executed by a section intersection point determination module running in the processor.

S3: determining a recommended traveling trajectory of the target road segment based on the driving-in section intersection point and the driving-out section intersection point.

In some optional examples, if the number of both the driving-in section intersection point and the driving-out section intersection point is one, first historical traveling trajectory information passing through the input section intersection point and passing through the driving-out section intersection point may be acquired from the historical traveling trajectory information, second historical traveling trajectory information passing through the input section intersection point and falling within a preset distance range from the driving-out section intersection point when passing through the driving-out section may also be acquired from the historical traveling trajectory information, and third historical traveling trajectory information falling within a preset distance range from the driving-in section intersection point when passing through the driving-in section and falling within a preset distance range from the driving-out section intersection point when passing through the driving-out section may also be acquired from the historical traveling trajectory information. A recommended traveling trajectory passing through the driving-in section intersection point and the driving-out section intersection point and having a smooth curve with a curvature lower than a preset curvature threshold may be generated based on positions of trajectory points of any one of the first historical traveling trajectory information, the second historical traveling trajectory information, and the third historical traveling trajectory information.

In some optional examples, if there are a plurality of driving-in section intersection points and/or driving-out section intersection points, a plurality of recommended traveling trajectories passing through different driving-in section intersection points and driving-out section intersection points and having smooth curves with a curvature lower than a preset curvature threshold may be generated.

FIG. 2 is a schematic diagram of determining a recommended traveling trajectory of a target road segment according to a driving-in section intersection point and a driving-out section intersection point in an example of the present disclosure. As shown in FIG. 2, a driving-in section of the target road segment is S, and a driving-out section thereof is E. There are a driving-in section intersection point S1, a driving-in section intersection point S2, a driving-in section intersection point S3, a driving-in section intersection point S4, a driving-in section intersection point S5, and a driving-in section intersection point S6 on the driving-in section. There are a driving-out section intersection point E1, a driving-out section intersection point E2, a driving-out section intersection point E3, a driving-out section intersection point E4, and a driving-out section intersection point E5 on the driving-out section. The recommended traveling trajectory of the target road segment may include: a recommended traveling trajectory from the driving-in section intersection point S1 to the driving-out section intersection point E1, a recommended traveling trajectory from the driving-in section intersection point S2 to the driving-out section intersection point E2, a recommended traveling trajectory from the driving-in section intersection point S3 to the driving-out section intersection point E3, a recommended traveling trajectory from the driving-in section intersection point S4 to the driving-out section intersection point E4, a recommended traveling trajectory from the driving-in section intersection point S5 to the driving-out section intersection point E5, and a recommended traveling trajectory from the driving-in section intersection point S6 to the driving-out section intersection point E5.

In an optional example, this step S3 may be executed by a processor calling corresponding instructions stored in a memory, and may also be executed by a recommended traveling trajectory determination module running in the processor.

In this embodiment, before performing traveling trajectory planning, the historical traveling trajectory information uploaded by the ego vehicle or another vehicle to a specified server after passing through the target road segment may be acquired, the plurality of historical driving-in trajectory points of the driving-in section and the plurality of historical driving-out trajectory points of the driving-out section of the target road segment may be extracted from the historical traveling trajectory information, the driving-in section intersection point of the target road segment may be rationally determined according to the plurality of historical driving-in trajectory points, the driving-out section intersection point of the target road segment may be rationally determined according to the plurality of historical driving-out trajectory points, and then the recommended traveling trajectory passing through the driving-in section intersection point and the driving-out section intersection point may be rationally planned according to the driving-in section intersection point and the driving-out section intersection point of the target road segment, such that it can both reduce the chances of vehicles being unable to drive into the planned path and ensure the operation stability and speed of vehicle.

FIG. 3 is a schematic flow diagram of step S2 in an example of the present disclosure. As shown in FIG. 3, step S2 may include:

S2-1: performing a first clustering on the plurality of historical driving-in trajectory points to determine the driving-in section intersection point.

In some optional embodiments, the first clustering may be performed on the plurality of historical trajectory points according to a set clustering distance, and the driving-in section intersection point is determined according to a result of the first clustering. For the historical driving-in trajectory points of each lane of the target road segment, clustering may be performed respectively to obtain the driving-in section intersection point of each lane. There may be one or more driving-in section intersection points of each lane.

If the target road segment is a unidirectional single-lane road segment, the driving-in section intersection point may include only one intersection point (for example, a central point) with the unidirectional single-lane road segment on the driving-in section. The driving-in section intersection point may also include a plurality of intersection points with the unidirectional single-lane road segment on the driving-in section, for example, in the case where the driving-in section of the target road segment is a driving-in section of a T-junction, the driving-in section intersection point may include an intersection point (generally, a central point) when the vehicle travels straight through the driving-in section of the T-junction, and an intersection point (generally, a non-central point) when the vehicle turns through the driving-in section of the T-junction.

If the target road segment is a unidirectional multi-lane road segment, for an outermost lane, one driving-in section intersection point may be determined, and the driving-in section intersection point may be, for example, a central point of a driving-in section of the outermost lane, or two driving-in section intersection points may be determined, and the two driving-in section intersection points may include, for example, the central point of the driving-in section of the outermost lane and a driving-in section intersection point determined due to a lane change from the adjacent lane to the outermost lane. For a middle lane other than the outermost lane, three driving-in section intersection points may be determined, and may include, for example, a central point of a driving-in section of the middle lane and driving-in section intersection points respectively determined due to a left-side lane change or a right-side lane change of the vehicle.

In addition, screening processing may also be performed based on the result of the first clustering to further reduce the number of the driving-in section intersection points. For example, a number threshold of historical traveling trajectory points of clustering points generated after the first clustering may be set, the clustering points lower than the number threshold are screened out, and the clustering points retained after screening are determined as driving-in section intersection points.

In an optional example, this step S2-1 may be executed by a processor calling corresponding instructions stored in a memory, and may also be executed by a first clustering unit running in the processor.

S2-2: performing a second clustering on the plurality of historical driving-out trajectory points to determine the driving-out section intersection point.

In some optional embodiments, the second clustering may be performed on the plurality of historical driving-out trajectory points in the same or similar manner as the first clustering to determine the driving-out section intersection point of the target road segment.

It should be noted that the sequential execution relationship of the first clustering and the second clustering is not defined in the embodiments of the present disclosure, the first clustering may be firstly performed and then the second clustering is performed (namely, step S2-1 is firstly executed and then step S2-2 is executed), the second clustering may also be firstly performed and then the first clustering is performed (namely, step S2-2 is firstly executed and then step S2-1 is executed), and the first clustering and the second clustering may also be executed simultaneously (namely, step S2-1 and step S2-2 are executed simultaneously).

In an optional example, this step S2-2 may be executed by a processor calling corresponding instructions stored in a memory, and may also be executed by a second clustering unit running in the processor.

In this embodiment, the first clustering is performed on the plurality of historical driving-in trajectory points to determine the driving-in section intersection point, and the second clustering is performed on the plurality of historical driving-out trajectory points to determine the driving-out section intersection point, the number of planning starting points and planning termination points during trajectory planning may be greatly reduced, which is helpful in improving the efficiency of generating the recommended traveling trajectory, and further helpful for the vehicle to travel according to the recommended traveling trajectory during automatic driving, such that it can both reduce the chances of vehicles being unable to drive into the planned path and ensure the operation stability and speed of vehicle.

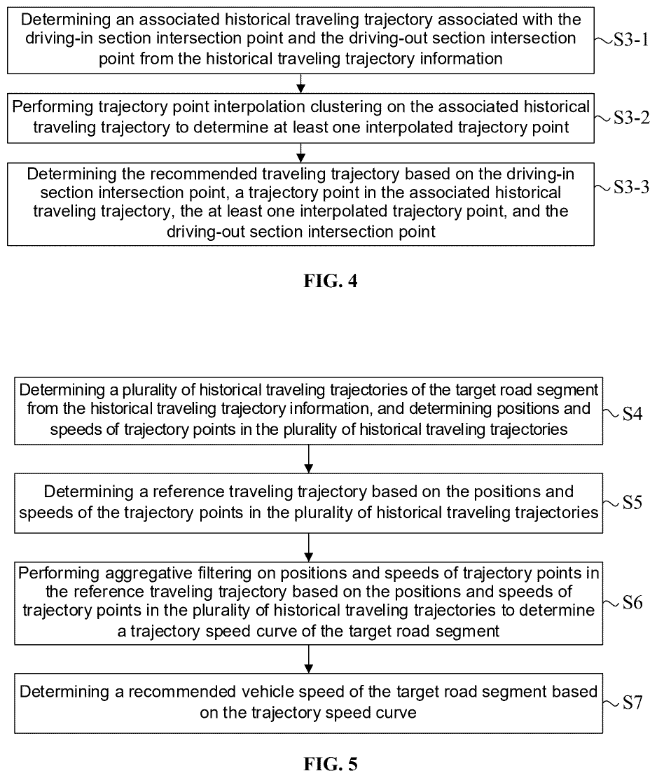

FIG. 4 is a schematic flow diagram of step S3 in an example of the present disclosure. As shown in FIG. 4, step S3 may include:

S3-1: determining an associated historical traveling trajectory associated with the driving-in section intersection point and the driving-out section intersection point from the historical traveling trajectory information.

In some optional embodiments, spacing between the driving-in section intersection point and a historical driving-in trajectory point corresponding to each historical traveling trajectory may be compared with a preset spacing threshold, and the historical traveling trajectories with the spacing less than the preset spacing threshold are determined as a first set of associated historical traveling trajectories associated with the driving-in section intersection point.

In some optional embodiments, spacing between the driving-out section intersection point and a historical driving-out trajectory point corresponding to each historical traveling trajectory may be compared with a preset spacing threshold, and the historical traveling trajectories with the spacing less than the preset spacing threshold are determined as a second set of associated historical traveling trajectories associated with the driving-out section intersection point.

In some optional embodiments, the same historical associated traveling trajectories in the first set of associated historical traveling trajectories and the second set of associated historical traveling trajectories may be determined as the associated historical traveling trajectories. Spacing between the historical driving-in trajectory point and the driving-in section intersection point of the associated historical traveling trajectory is less than the preset spacing threshold, and spacing between the historical driving-out trajectory point and the driving-out section intersection point is less than the preset spacing threshold. That is, the positions of a driving-in point and a driving-out point of the associated historical traveling trajectory and the recommended traveling trajectory in the target road segment are close.

In an optional example, this step S3-1 may be executed by a processor calling corresponding instructions stored in a memory, and may also be executed by an associated historical traveling trajectory determination unit running in the processor.

S3-2: performing interpolation clustering on trajectory points of the associated historical traveling trajectory to determine at least one interpolated trajectory point.

In some optional embodiments, trajectory point interpolation may be performed on the trajectory-associated historical traveling trajectory according to the positions of a plurality of trajectory points of the associated historical traveling trajectory, so as to increase the number of trajectory points of the associated historical traveling trajectory. Clustering is performed on the interpolated trajectory points to obtain trajectory points which are most likely to be passed by the vehicle between the driving-in section intersection point and the driving-out section intersection point, that is, at least one interpolated trajectory point.

In an optional example, this step S3-2 may be executed by a processor calling corresponding instructions stored in a memory, and may also be executed by a trajectory point interpolation clustering unit running in the processor.

S3-3: determining the recommended traveling trajectory based on the driving-in section intersection point, a trajectory point in the associated historical traveling trajectory, the at least one interpolated trajectory point, and the driving-out section intersection point.

When the recommended traveling trajectory planning is performed, at least one recommended traveling trajectory with the driving-in section intersection point as a starting point and the driving-out section intersection point as an end point, passing through the driving-in section intersection point, the trajectory points in the associated historical traveling trajectory, the at least one interpolated trajectory point, and the driving-out section intersection point may be planned.

In an optional example, this step S3-3 may be executed by a processor calling corresponding instructions stored in a memory, and may also be executed by a recommended traveling trajectory determination unit running in the processor.

In this example, the associated historical traveling trajectory associated with the driving-in section intersection point and the driving-out section intersection point is determined from the historical traveling trajectory information, the trajectory point interpolation clustering is performed on the associated historical traveling trajectory to obtain at least one interpolated trajectory point, and at least one recommended traveling trajectory with the driving-in section intersection point as the starting point and the driving-out section intersection point as the end point, passing through the driving-in section intersection point, the trajectory points in the associated historical traveling trajectory, the at least one interpolated trajectory point, and the driving-out section intersection point may be rationally planned, which is helpful for the vehicle to travel according to the recommended traveling trajectory during automatic driving, such that it can both reduce the chances of vehicles being unable to drive into the planned path and ensure the operation stability and speed of vehicle.

FIG. 5 is a schematic flow diagram after step S3 in an example of the present disclosure. As shown in FIG. 5, in an example of the present disclosure, the method for determining a vehicle traveling trajectory may further include:

S4: determining a plurality of historical traveling trajectories of the target road segment from the historical traveling trajectory information, and determining positions and speeds of trajectory points in the plurality of historical traveling trajectories.

In the case where at least one vehicle travels in the target road segment, each vehicle may not only send a trajectory position thereof to a specified server, but also send vehicle speed information thereof to the specified server. In this way, the specified server may store historical traveling trajectory information including the trajectory point position and vehicle speed.

In some optional embodiments, the positions and speeds of trajectory points of the plurality of historical traveling trajectories of the target road segment may be extracted from the historical traveling trajectory information acquired by the specified server, and a plurality of historical traveling trajectories may be generated according to the positions and speeds of trajectory points.

In an optional instance, this step S4 may be executed by a processor calling corresponding instructions stored in a memory, and may also be executed by a trajectory information determination module running in the processor.

S5: determining a reference traveling trajectory based on the positions and speeds of the trajectory points in the plurality of historical traveling trajectories. The reference traveling trajectory is one of the plurality of historical traveling trajectories.

In some optional embodiments, trajectory speed curves of the plurality of historical traveling trajectories may be generated based on the positions and speeds of trajectory points of the plurality of historical traveling trajectories. The evaluation is performed based on the trajectory speed curves of the plurality of historical traveling trajectories according to a preset evaluation rule, and the historical traveling trajectory with the highest evaluation score is determined as the reference traveling trajectory.

In an optional instance, this step S5 may be executed by a processor calling corresponding instructions stored in a memory, and may also be executed by a reference traveling trajectory determination module running in the processor.

S6: performing aggregative filtering on pairs of positions and speeds of trajectory points in the reference traveling trajectory based on the positions and speeds of trajectory points in the plurality of historical traveling trajectories to determine a trajectory speed curve of the target road segment.

In some optional embodiments, aggregative processing may be performed on the pairs of the positions and speeds of trajectory points in the reference traveling trajectory according to the position and speed of the trajectory point in the plurality of historical traveling trajectories by utilizing an influence model to obtain a first trajectory speed curve. A Gaussian model or other models may be selected as the influence model.

In some optional embodiments, since the first trajectory speed curve obtained through the aggregative processing may be subjected to speed and position deformation, filtering processing may be performed on the first trajectory speed curve to obtain a second trajectory speed curve after eliminating the deformation, and the second trajectory speed curve is determined as a trajectory speed curve of the target road segment.

In an optional instance, this step S6 may be executed by a processor calling corresponding instructions stored in a memory, and may also be executed by a trajectory speed curve determination module running in the processor.

S7: determining a recommended vehicle speed of the target road segment based on the trajectory speed curve.

In some optional embodiments, recommended vehicle speeds of the vehicle at different positions of the target road segment may be determined based on the trajectory speed curve.

In an optional example, this step S7 may be executed by a processor calling corresponding instructions stored in a memory, and may also be executed by a recommended vehicle speed determination module running in the processor.

In this embodiment, the reference traveling trajectory is selected from the plurality of historical traveling trajectories of the target road segment, and the aggregative filtering is performed on the reference traveling trajectory according to the positions and speeds of trajectory points in the plurality of historical traveling trajectories to obtain the trajectory speed curve representing the recommended vehicle speeds at different positions of the target road segment, and then the recommended vehicle speed of the target road segment may be rationally obtained according to the trajectory speed curve, thereby being helpful in improving the vehicle speed rationality and the vehicle safety during traveling according to the recommended vehicle speed of the vehicle in the automatic driving mode.

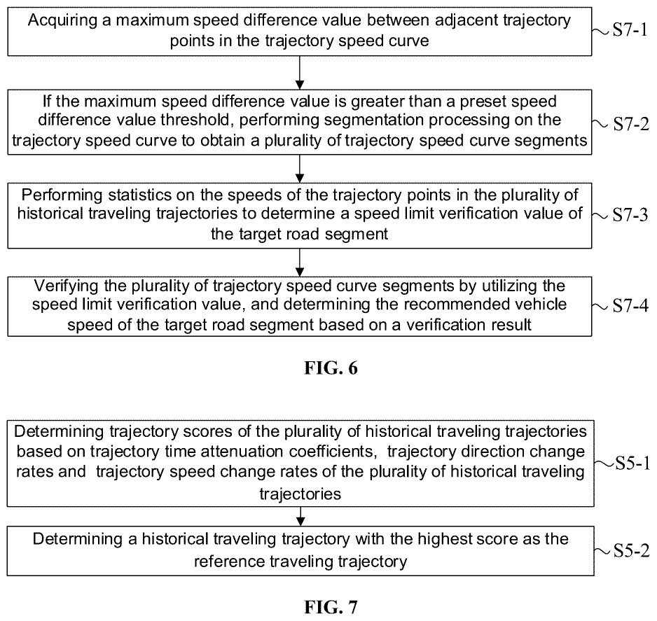

FIG. 6 is a schematic flow diagram of step S7 in an example of the present disclosure. As shown in FIG. 6, step S7 may include:

S7-1: acquiring a maximum speed difference value between adjacent trajectory points in the trajectory speed curve.

In some optional embodiments, vehicle speeds at different position points of the target road segment may be extracted from the trajectory speed curve of the target road segment, and speed difference values between adjacent trajectory points are compared to obtain the maximum speed difference value between the adjacent trajectory points.

In an optional instance, this step S7-1 may be executed by a processor calling corresponding instructions stored in a memory, and may also be executed by a maximum speed difference value acquisition unit running in the processor.

S7-2: if the maximum speed difference value is greater than a preset speed difference value threshold, performing segmentation processing on the trajectory speed curve to obtain a plurality of trajectory speed curve segments.

If the maximum speed difference value is greater than the preset speed difference value threshold, a speed limit signboard may be provided between adjacent position points corresponding to the maximum speed difference value, and at this time, the segmentation processing may be performed on the trajectory speed curve to obtain the plurality of trajectory speed curve segments. Different trajectory speed curve segments may represent that the vehicle has different vehicle speed ranges.

In an optional example, this step S7-2 may be executed by a processor calling corresponding instructions stored in a memory, and may also be executed by a segmentation processing unit running in the processor.

S7-3: performing statistics based on the speed of the trajectory points in the plurality of historical traveling trajectories to determine a speed limit verification value of the target road segment.

In an example of the embodiment of the present disclosure, an average speed value may be calculated for the speeds of the trajectory points of the plurality of historical traveling trajectories, and the average speed value is multiplied by a coefficient between 0 and 1 to obtain the speed limit verification value. The coefficient may be a preset numerical value between 0.8 and 0.9, for example, the coefficient may be 0.85.

In an optional example, this step S7-3 may be executed by a processor calling corresponding instructions stored in a memory, and may also be executed by a speed limit verification value determination unit running in the processor.

S7-4: verifying the plurality of trajectory speed curve segments by utilizing the speed limit verification value, and determining the recommended vehicle speed of the target road segment based on a verification result.

In some optional embodiments, average vehicle speeds of the plurality of trajectory speed curve segments may be calculated. If the average vehicle speed of a certain trajectory speed curve segment is less than the speed limit verification value, it may be determined that the trajectory speed curve segment passes the verification, and the average speed of the trajectory speed curve segment may be determined as the recommended vehicle speed of the trajectory speed curve segment; and if the average vehicle speed of a certain trajectory speed curve segment is greater than or equal to the speed limit verification value, it may be determined that the trajectory speed curve segment fails to pass the verification, at this time, the trajectory speed curve of the trajectory speed curve segment may be adjusted, and the verification is performed again until the verification is passed, so as to obtain the recommended vehicle speed of the trajectory speed curve segment, thereby being helpful in improving the vehicle speed rationality and the vehicle safety during traveling according to the recommended vehicle speed of the vehicle in the automatic driving mode.

In an optional example, this step S7-4 may be executed by a processor calling corresponding instructions stored in a memory, and may also be executed by a recommended vehicle speed determination unit running in the processor.

In this embodiment, the maximum speed difference value between the adjacent trajectory points in the trajectory speed curve is compared with the preset speed difference value threshold, and the target road segment is segmented into a plurality of trajectory speed curve segments according to a comparison result. The statistics is performed on the trajectory points of the plurality of historical traveling trajectories to obtain the speed limit verification value of the target road segment, for example, the recommended vehicle speed of the target road segment may be rationally obtained by verifying the plurality of trajectory speed curve segments with the speed limit verification value.

FIG. 7 is a schematic flow diagram of step S5 in an example of the present disclosure. As shown in FIG. 7, step S5 may include:

S5-1: determining trajectory scores of the plurality of historical traveling trajectories based on trajectory time attenuation coefficients, trajectory direction change rates and trajectory speed change rates of the plurality of historical traveling trajectories.

In some optional embodiments, log functions, or functions which can achieve the same objective may be used as the time attenuation coefficients. The direction change rates of the trajectories may represent the traveling stability and comfort of the vehicle. The speed change rates of the trajectories may reflect the density of traffic flow on the target road segment.

In some optional embodiments, the plurality of historical traveling trajectories may be scored based on the trajectory time attenuation coefficients, trajectory direction change rates and trajectory speed change rates of the plurality of historical traveling trajectories to obtain the trajectory scores of the plurality of historical traveling trajectories. The trajectory scores may comprehensively represent the indicators such as the stability, comfort and traffic flow density of the historical traveling trajectories.

In an optional example, this step S5-1 may be executed by a processor calling corresponding instructions stored in a memory, and may also be executed by a trajectory scoring unit running in the processor.

S5-2: determining a historical traveling trajectory with the highest score as the reference traveling trajectory.

In an optional example, this step S5-2 may be executed by a processor calling corresponding instructions stored in a memory, and may also be executed by a reference traveling trajectory determination unit running in the processor.

In this embodiment, the time attenuation coefficient may represent a time influence degree of a distance of the historical traveling trajectory on a trajectory planning moment, the direction change rate of the trajectory may represent the traveling stability and comfort of the vehicle, and the speed change rate of the trajectory may reflect the density of traffic flow on the target road segment. The plurality of historical traveling trajectories are scored based on the trajectory time attenuation coefficients of the plurality of historical traveling trajectories, and the direction change rates and the speed change rates of the trajectories, and the historical traveling trajectory with the highest score is determined as the reference traveling trajectory, so that comprehensive optimization of stability, comfort and traffic flow density may be achieved, which is helpful in generating a trajectory speed curve of the target road segment which is comprehensively optimized in the dimensions of stability, comfort and traffic flow density, and further helpful in generating a recommended vehicle speed of the target road segment which is comprehensively optimized in the dimensions of stability, comfort and traffic flow density, thereby being helpful in achieving comprehensive optimization of vehicle traveling in the dimensions of stability, comfort and traffic flow density during automatic driving.

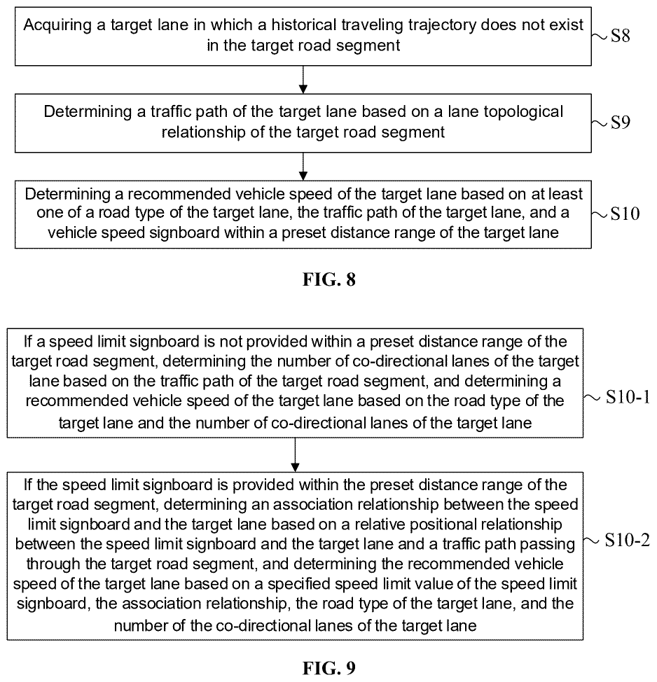

FIG. 8 is a schematic diagram of a partial flow of the method for determining a vehicle traveling trajectory in an example of the present disclosure. As shown in FIG. 8, in an example of the present disclosure, the method for determining a vehicle traveling trajectory may further include:

S8: acquiring a target lane in which a historical traveling trajectory does not exist in the target road segment.

If the target road segment is a multi-lane road segment, due to fewer historical traveling trajectories in the target road segment, or due to a driving habit of a driver, there may be a target lane in which the historical traveling trajectory does not exist on the target road segment.

In an optional example, this step S8 may be executed by a processor calling corresponding instructions stored in a memory, and may also be executed by a target lane determination unit running in the processor.

S9: determining a traffic path of the target lane based on a lane topological relationship of the target road segment.

The lane topological relationship of the target road segment may include communication of various lanes inside the target road segment. Lane information of the target lane and information of other lanes in communication with the target lane may be acquired from the lane topological relationship of the target road segment. The traffic path of the target lane may be established based on the lane information of the target lane and the information of other lanes in communication with the target lane.

In an optional example, this step S9 may be executed by a processor calling corresponding instructions stored in a memory, and may also be executed by a traffic path determination unit running in the processor.

S10: determining a recommended vehicle speed of the target lane based on at least one of a road type of the target lane, the traffic path of the target lane, and a vehicle speed signboard within a preset distance range of the target lane.

The road type of the target lane may include an expressway, a first-class highway, a second-class highway, a third-class highway, and a fourth-class highway. The first-class highway may be a highway connected to important political and economic centers, or the first-class highway may be a highway leading to key airports and ports. The second-class highway may also be a highway connected to political and economic centers which may be of a lower level than the first-class highway, for example, the second-class highway may be a highway connected to ordinary political and economic centers or leading to general airports and ports. The third-class highway may be a highway used for communicating cities above the county level. The fourth-class highway may be a highway used for communicating counties, towns and villages. Different road types generally have different speed limits, or different recommended vehicle speeds.

In some optional embodiments, other lanes in communication with the target lane in the traffic path of the target lane may already have the recommended vehicle speeds.

In some optional embodiments, the vehicle speed signboard within the preset distance range of the target lane may be for the target lane, and at this time, a speed limit value of the speed limit signboard may affect the recommended vehicle speed of the target lane.

The recommended vehicle speed of the target lane may be rationally determined based on at least one of the road type of the target lane, the traffic path of the target lane, and the vehicle speed signboard within the preset distance range of the target lane.

In an optional example, this step S10 may be executed by a processor calling corresponding instructions stored in a memory, and may also be executed by a recommended vehicle speed determination unit running in the processor.

In this embodiment, since the road types of the target lane generally have different speed limits, or different recommended vehicle speeds, other lanes in communication with the target lane in the traffic path of the target lane may already have the recommended vehicle speeds, and the vehicle speed signboard within the preset distance range of the target lane may be the recommended vehicle speed of the target lane, the recommended vehicle speed of the target lane may be rationally determined based on at least one of the road type of the target lane, the traffic path of the target lane, and the vehicle speed signboard within the preset distance range of the target lane, thereby being helpful in improving the vehicle speed rationality and the vehicle safety during traveling according to the recommended vehicle speed of the vehicle in the automatic driving mode.

FIG. 9 is a schematic flow diagram of step S10 in an example of the present disclosure. As shown in FIG. 9, step S10 may include:

S10-1: if a speed limit signboard is not provided within a preset distance range of the target road segment, the number of co-directional lanes of the target lane is determined based on the traffic path of the target road segment, and a recommended vehicle speed of the target lane is determined based on the road type of the target lane and the number of co-directional lanes of the target lane.

If the speed limit signboard is not provided within the preset distance range of the target road segment, speed limit information of the target lane cannot be directly acquired. Since different road types generally have different speed limits, or different recommended vehicle speeds, and the greater the number of the co-directional lanes is, the higher the speed limit value is, the recommended vehicle speed of the target lane may be rationally determined according to the road type of the target lane and the number of the co-directional lanes of the target lane.

In an optional example, this step S10-1 may be executed by a processor calling corresponding instructions stored in a memory, and may also be executed by a recommended vehicle speed determination unit running in the processor.

S10-2: if the speed limit signboard is provided within the preset distance range of the target road segment, an association relationship between the speed limit signboard and the target lane is determined based on a relative positional relationship between the speed limit signboard and the target lane and a traffic path passing through the target road segment, and the recommended vehicle speed of the target lane is determined based on a specified speed limit value of the speed limit signboard, the association relationship, the road type of the target lane, and the number of the co-directional lanes of the target lane.

If the speed limit signboard is provided within the preset distance range of the target road segment, the specified speed limit value of the speed limit signboard may give a speed limit prompt for the target lane, or may give a speed limit prompt for a lane other than the target lane. The association relationship between the speed limit signboard and the target lane may be determined according to the traffic path of the target road segment, that is, whether the speed limit signboard gives a speed limit prompt for the target lane.

If it is determined that the speed limit signboard gives a speed limit prompt for the target lane based on the association relationship, the recommended vehicle speed of the target lane may be rationally determined according to the specified speed limit value of the speed limit signboard, the road type of the target lane, and the number of the co-directional lanes of the target lane. If it is determined that the speed limit signboard does not give a speed limit prompt for the target lane based on the association relationship, the recommended vehicle speed of the target lane may be rationally determined according to the road type of the target lane, and the number of the co-directional lanes of the target lane.

In an optional example, this step S10-2 may be executed by a processor calling corresponding instructions stored in a memory, and may also be executed by a recommended vehicle speed determination unit running in the processor.

In this embodiment, the recommended vehicle speed of the target lane may be rationally determined according to whether the speed limit signboard is provided within the preset distance range of the target road segment in combination with the association relationship between the speed limit signboard and the target lane, the road type of the target lane, and the number of the co-directional lanes of the target lane, thereby being helpful in improving the vehicle speed rationality and the vehicle safety during traveling according to the recommended vehicle speed of the vehicle in the automatic driving mode.

Any one of the methods for determining a vehicle traveling trajectory provided in the embodiments of the present disclosure may be executed by any suitable device having a data processing capability, including, but not limited to: a terminal device and a server, and the like. Alternatively, any one of the methods for determining a vehicle traveling trajectory provided in the examples of the present disclosure may be executed by a processor, for example, the processor executes any one of the methods for determining a vehicle traveling trajectory mentioned in the embodiments of the present disclosure by calling corresponding instructions stored in a memory, which will not be described in detail below.

Those ordinarily skilled in the art will understand that all or some of the steps for implementing the above method examples may be completed by hardware related to program instructions, and the above program may be stored in a computer-readable storage medium, which, when executed, implements the steps including the above method examples; and the above storage medium includes: various media which may store program codes, such as an ROM, an RAM, a diskette or an optical disk.

### Illustrative Apparatus

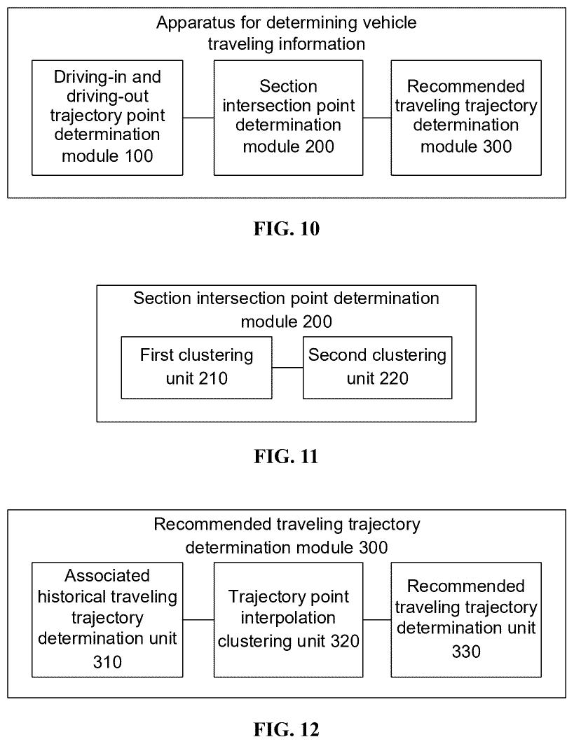

FIG. 10 is a structural block diagram of an apparatus for determining a vehicle traveling trajectory in an example of the present disclosure. As shown in FIG. 10, the apparatus for determining a vehicle traveling trajectory may include: a driving-in and driving-out trajectory point determination module 100, a section intersection point determination module 200, and a recommended traveling trajectory determination module 300.

The driving-in and driving-out trajectory point determination module 100 may be configured for: based on historical traveling trajectory information of at least one vehicle on a target road segment, determining a plurality of historical driving-in trajectory points of a driving-in section of the target road segment, and extracting a plurality of historical driving-out trajectory points of a driving-out section of the target road segment.

The section intersection point determination module 200 may be configured for determining a driving-in section intersection point of the target road segment based on the plurality of historical driving-in trajectory points, and determining a driving-out section intersection point of the target road segment based on the plurality of historical driving-out trajectory points.

The recommended traveling trajectory determination module 300 may be configured for determining a recommended traveling trajectory of the target road segment based on the driving-in section intersection point and the driving-out section intersection point.

FIG. 11 is a structural block diagram of a section intersection point determination module 200 in an example of the present disclosure. As shown in FIG. 11, the section intersection point determination module 200 may include: a first clustering unit 210 and a second clustering unit 220.

The first clustering unit 210 may be configured for performing first clustering on the plurality of historical driving-in trajectory points to determine the driving-in section intersection point.

The second clustering unit 220 may be configured for performing second clustering on the plurality of historical driving-out trajectory points to determine the driving-out section intersection point.

FIG. 12 is a structural block diagram of a recommended traveling trajectory determination module 300 in an example of the present disclosure. As shown in FIG. 12, the recommended traveling trajectory determination module 300 may include: an associated historical traveling trajectory determination unit 310, a trajectory point interpolation clustering unit 320, and a recommended traveling trajectory determination unit 330.

The associated historical traveling trajectory determination unit 310 may be configured for determining an associated historical traveling trajectory associated with the driving-in section intersection point and the driving-out section intersection point from the historical traveling trajectory information.

The trajectory point interpolation clustering unit 320 may be configured for performing interpolation clustering on trajectory points of the associated historical traveling trajectory to obtain at least one interpolated trajectory point.

The recommended traveling trajectory determination unit 330 may be configured for determining the recommended traveling trajectory based on the driving-in section intersection point, trajectory points in the associated historical traveling trajectory, the at least one interpolated trajectory point, and the driving-out section intersection point.

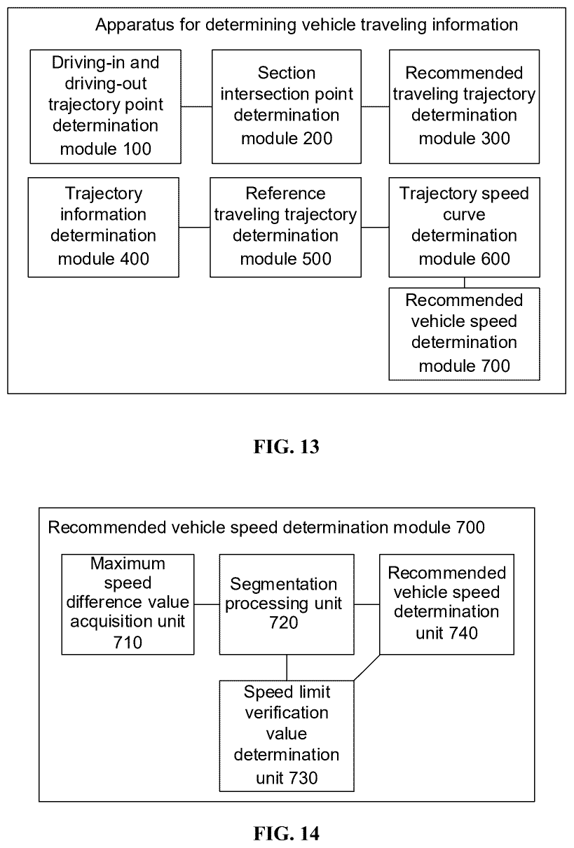

FIG. 13 is a structural block diagram of the apparatus for determining a vehicle traveling trajectory in another example of the present disclosure. As shown in FIG. 13, the apparatus for determining a vehicle traveling trajectory may further include: a trajectory information determination module 400, a reference traveling trajectory determination module 500, a trajectory speed curve determination module 600, and a recommended vehicle speed determination module 700.

The trajectory information determination module 400 may be configured for determining a plurality of historical traveling trajectories of the target road segment from the historical traveling trajectory information, and determining the positions and speeds of trajectory points in the plurality of historical traveling trajectories.

The reference traveling trajectory determination module 500 may be configured for determining a reference traveling trajectory based on the positions and speeds of trajectory points in the plurality of historical traveling trajectories. The reference traveling trajectory is one historical traveling trajectory in the plurality of historical traveling trajectories.

The trajectory speed curve determination module 600 may be configured for performing aggregative filtering on pairs of the positions and speeds of trajectory points in the reference traveling trajectory based on the positions and speeds of trajectory points in the plurality of historical traveling trajectories to determine a trajectory speed curve of the target road segment.

The recommended vehicle speed determination module 700 may be configured for determining a recommended vehicle speed of the target road segment based on the trajectory speed curve.

FIG. 14 is a structural block diagram of a recommended vehicle speed determination module 700 in an example of the present disclosure. As shown in FIG. 14, the recommended traveling trajectory determination module 700 may include: a maximum speed difference value acquisition unit 710, a segmentation processing unit 720, a speed limit verification value determination unit 730, and a recommended vehicle speed determination unit 740.

The maximum speed difference value acquisition unit 710 may be configured for acquiring a maximum speed difference value between adjacent trajectory points in the trajectory speed curve.

The segmentation processing unit 720 may be configured for: if the maximum speed difference value is greater than a preset speed difference value threshold, performing segmentation processing on the trajectory speed curve to obtain a plurality of trajectory speed curve segments.

The speed limit verification value determination unit 730 may be configured for performing statistics on the speed of trajectory points of the plurality of historical traveling trajectories to obtain a speed limit verification value of the target road segment.

The recommended vehicle speed determination unit 740 may be configured for verifying the plurality of trajectory speed curve segments by utilizing the speed limit verification value, and determining the recommended vehicle speed of the target road segment based on a verification result.

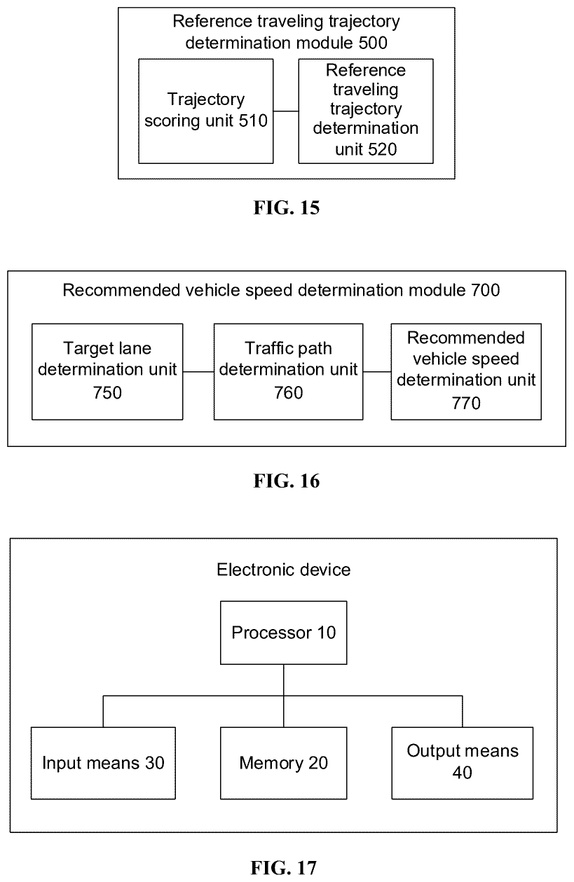

FIG. 15 is a structural block diagram of a reference traveling trajectory determination module 500 in an example of the present disclosure. As shown in FIG. 15, the reference traveling trajectory determination module 500 may include: a trajectory scoring unit 510 and a reference traveling trajectory determination unit 520.

The trajectory scoring unit 510 may be configured for determining trajectory scores of the plurality of historical traveling trajectories based on trajectory time attenuation coefficients, trajectory direction change rates and trajectory speed change rates of the plurality of historical traveling trajectories.

The reference traveling trajectory determination unit 520 may be configured for determining the historical traveling trajectory with the highest score as the reference traveling trajectory.

FIG. 16 is a structural block diagram of the recommended vehicle speed determination module 700 in another example of the present disclosure. As shown in FIG. 16, the recommended vehicle speed determination module 700 may further include: a target lane determination unit 750, a traffic path determination unit 760, and a recommended vehicle speed determination unit 770.

The target lane determination unit 750 may be configured for acquiring a target lane in which a historical traveling trajectory does not exist in the target road segment.

The traffic path determination unit 760 may be configured for determining a traffic path of the target lane based on a lane topological relationship of the target road segment.

The recommended vehicle speed determination unit 770 may be configured for determining a recommended vehicle speed of the target lane based on at least one of a road type of the target lane, the traffic path of the target lane, and a vehicle speed signboard within a preset distance range of the target lane.

In an embodiment of the present disclosure, the recommended vehicle speed determination unit 770 is configured for: if a speed limit signboard is not provided within a preset distance range of the target road segment, determining the number of co-directional lanes of the target lane based on the traffic path of the target road segment, and determining a recommended vehicle speed of the target lane based on the road type of the target lane and the number of co-directional lanes of the target lane; and the recommended vehicle speed determination unit 770 is further configured for: if the speed limit signboard is provided within the preset distance range of the target road segment, determining an association relationship between the speed limit signboard and the target lane based on a relative positional relationship between the speed limit signboard and the target lane and a traffic path passing through the target road segment, and determining the recommended vehicle speed of the target lane based on a specified speed limit value of the speed limit signboard, the association relationship, the road type of the target lane, and the number of the co-directional lanes of the target lane.

It should be noted that the specific implements of the apparatus for determining a vehicle traveling trajectory in the embodiments of the present disclosure are similar to the specific implements of the method for determining a vehicle traveling trajectory in the embodiments of the present disclosure, and reference may be made to the corresponding beneficial technical effects of the above illustrative method section for the beneficial technical effects corresponding to the illustrative examples of the apparatus, which will not be described in detail herein.

### Illustrative Electronic Device

FIG. 17 is a structural block diagram of an electronic device in an example of the present disclosure. As shown in FIG. 17, the electronic device includes at least one processor 10 and a memory 20.

The processor 10 may be a central processing unit (CPU) or processing units having data processing capabilities and/or instruction executing capabilities in other forms, and may control other components in the electronic device to execute the desired functions.

The memory 20 may include one or more computer program products, which may include computer-readable storage media in various forms, such as a volatile memory and/or a non-volatile memory. The volatile memory may include, for example, a random access memory (RAM) and/or a cache, and the like. The non-volatile memory may include, for example, a read-only memory (ROM), a hard disk, a flash memory, and the like. One or more computer program instructions may be stored on the computer-readable storage medium, and the processor 11 may run one or more computer program instructions to implement the above methods for determining a vehicle traveling trajectory in various examples of the present disclosure and/or other desired functions.

In an example, the electronic device may further include: an input means 30 and an output means 40, and these components are interconnected by a bus system and/or connection mechanisms in other forms (not shown).

The input means 30 may further include, for example, a keyboard, a mouse, and the like.

The output means 40 may output various types of information to the outside, which may include, for example, a display, a speaker, a printer, and a communication network and a remote output device connected thereto, and the like.

Of course, for simplicity, only some of the components in the electronic device related to the present disclosure are shown in FIG. 17, with components such as buses, and input/output interfaces omitted. In addition, the electronic device may further include any other suitable components, depending on the specific application situations.

Illustrative computer program product and computer-readable storage medium

In addition to the method and apparatus described above, in an embodiment of the present disclosure there may be further provided a computer program product, including computer program instructions which, when run by a processor, cause the processor to implement the steps in the methods for determining a vehicle traveling trajectory in various examples of the present disclosure described in the above “illustrative method” section.

The computer program product may include write program codes for executing the operation of the examples of the present disclosure written in any combination of one or more programming languages, and the programming languages include object-oriented programming languages such as Java and C++, and further include conventional procedural programming languages such as “C” language or similar programming languages. The program codes may be executed entirely on a user computing device, partly on the user computing device, as a stand-alone software package, partly on the user computing device and partly on a remote computing device, or entirely on the remote computing device or a server.

In addition, in the embodiment of the present disclosure there may also be provided a computer-readable storage medium having computer program instructions stored thereon, which, when run by a processor, cause the processor to implement the steps in the methods for determining a vehicle traveling trajectory in various embodiments of the present disclosure described in the above “illustrative method” section.

Any combination of one or more readable media may be adopted as the computer-readable storage medium. The readable medium may be a readable signal medium or a readable storage medium. The readable storage medium includes, for example, but not limited to, electrical, magnetic, optical, electromagnetic, infrared, or semiconductor systems, apparatuses or devices, or any combination thereof. More specific instances (a non-exhaustive list) of the readable storage medium include: electrical connection having one or more lead wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

While the general principles of the present disclosure have been described above in conjunction with specific embodiments, the merits, advantages, effects, and the like set forth in the present disclosure are merely illustrative but not limiting, and are not to be construed as being necessarily required in various embodiments of the present disclosure. In addition, the specific details disclosed above are only for the purposes of illustrating and facilitating understanding, and are not intended to be limiting, and the above details do not restrict the implementation of the present disclosure by adopting the specific details disclosed above.

Various modifications and alterations of the present disclosure may be made by those skilled in the art without departing from the spirit and scope of the present application. Thus, it is intended that these modifications and alterations of the present application fall within the scope of the claims of the present disclosure and their equivalents.

1.-10. (canceled)

11. A method for determining a vehicle traveling trajectory, comprising:
based on historical traveling trajectory information of at least one vehicle on a target road segment, determining a plurality of historical driving-in trajectory points of a driving-in section of the target road segment, and determining a plurality of historical driving-out trajectory points of a driving-out section of the target road segment;
determining a driving-in section intersection point of the target road segment based on the plurality of historical driving-in trajectory points, and determining a driving-out section intersection point of the target road segment based on the plurality of historical driving-out trajectory points; and
determining a recommended traveling trajectory of the target road segment based on the driving-in section intersection point and the driving-out section intersection point.

12. The method according to claim 11, wherein the determining a driving-in section intersection point of the target road segment based on the plurality of historical driving-in trajectory points, and determining a driving-out section intersection point of the target road segment based on the plurality of historical driving-out trajectory points, comprises:
performing a first clustering on the plurality of historical driving-in trajectory points to determine the driving-in section intersection point; and
performing a second clustering on the plurality of historical driving-out trajectory points to determine the driving-out section intersection point.

13. The method according to claim 11, wherein the determining a recommended traveling trajectory of the target road segment based on the driving-in section intersection point and the driving-out section intersection point, comprises:
determining an associated historical traveling trajectory associated with the driving-in section intersection point and the driving-out section intersection point from the historical traveling trajectory information;
performing interpolation clustering on trajectory points of the associated historical traveling trajectory to determine at least one interpolated trajectory point; and
determining the recommended traveling trajectory based on the driving-in section intersection point, a trajectory point in the associated historical traveling trajectory, the at least one interpolated trajectory point, and the driving-out section intersection point.

14. The method according to claim 11, further comprising:
determining a plurality of historical traveling trajectories of the target road segment from the historical traveling trajectory information, and determining positions and speeds of trajectory points in the plurality of historical traveling trajectories;
determining a reference traveling trajectory based on the positions and speeds of the trajectory points in the plurality of historical traveling trajectories, wherein the reference traveling trajectory is one of the plurality of historical traveling trajectories;
performing aggregative filtering on positions and speeds of trajectory points in the reference traveling trajectory based on the position and speed of the trajectory points in the plurality of historical traveling trajectories to determine a trajectory speed curve of the target road segment; and
determining a recommended vehicle speed of the target road segment based on the trajectory speed curve.

15. The method according to claim 14, wherein the determining a recommended vehicle speed of the target road segment based on the trajectory speed curve, comprises:
acquiring a maximum speed difference value between adjacent trajectory points in the trajectory speed curve;
if the maximum speed difference value is greater than a preset speed difference value threshold, performing segmentation processing on the trajectory speed curve to obtain a plurality of trajectory speed curve segments;
performing statistics on the speeds of the trajectory points in the plurality of historical traveling trajectories to determine a speed limit verification value of the target road segment; and
verifying the plurality of trajectory speed curve segments by utilizing the speed limit verification value, and determining the recommended vehicle speed of the target road segment based on a verification result.

16. The method according to claim 14, wherein the determining a reference traveling trajectory based on the positions and speeds of the trajectory points in the plurality of historical traveling trajectories, comprises:
determining trajectory scores of the plurality of historical traveling trajectories based on trajectory time attenuation coefficients, trajectory direction change rates and trajectory speed change rates of the plurality of historical traveling trajectories; and
determining a historical traveling trajectory with the highest score as the reference traveling trajectory.

17. The method according to claim 11, further comprising:
acquiring a target lane in which a historical traveling trajectory does not exist in the target road segment;
determining a traffic path of the target lane based on a lane topological relationship of the target road segment; and
determining a recommended vehicle speed of the target lane based on at least one of a road type of the target lane, the traffic path of the target lane, and a vehicle speed signboard within a preset distance range of the target lane.

18. A non-transitory computer-readable storage medium having a computer program stored thereon, which, when executed by a processor, causes the processor to implement the following:
based on historical traveling trajectory information of at least one vehicle on a target road segment, determining a plurality of historical driving-in trajectory points of a driving-in section of the target road segment, and determining a plurality of historical driving-out trajectory points of a driving-out section of the target road segment;
determining a driving-in section intersection point of the target road segment based on the plurality of historical driving-in trajectory points, and determining a driving-out section intersection point of the target road segment based on the plurality of historical driving-out trajectory points; and
determining a recommended traveling trajectory of the target road segment based on the driving-in section intersection point and the driving-out section intersection point.

19. The storage medium according to claim 18, wherein the determining a driving-in section intersection point of the target road segment based on the plurality of historical driving-in trajectory points, and determining a driving-out section intersection point of the target road segment based on the plurality of historical driving-out trajectory points, comprises:
performing a first clustering on the plurality of historical driving-in trajectory points to determine the driving-in section intersection point; and
performing a second clustering on the plurality of historical driving-out trajectory points to determine the driving-out section intersection point.

20. The storage medium according to claim 18, wherein the determining a recommended traveling trajectory of the target road segment based on the driving-in section intersection point and the driving-out section intersection point, comprises:
determining an associated historical traveling trajectory associated with the driving-in section intersection point and the driving-out section intersection point from the historical traveling trajectory information;
performing interpolation clustering on trajectory points of the associated historical traveling trajectory to determine at least one interpolated trajectory point; and
determining the recommended traveling trajectory based on the driving-in section intersection point, a trajectory point in the associated historical traveling trajectory, the at least one interpolated trajectory point, and the driving-out section intersection point.

21. The storage medium according to claim 18, further comprising:
determining a plurality of historical traveling trajectories of the target road segment from the historical traveling trajectory information, and determining positions and speeds of trajectory points in the plurality of historical traveling trajectories;
determining a reference traveling trajectory based on the position and speed of the trajectory points in the plurality of historical traveling trajectories, wherein the reference traveling trajectory is one of the plurality of historical traveling trajectories;
performing aggregative filtering on positions and speeds of trajectory points in the reference traveling trajectory based on the position and speed of the trajectory points in the plurality of historical traveling trajectories to determine a trajectory speed curve of the target road segment; and
determining a recommended vehicle speed of the target road segment based on the trajectory speed curve.

22. The storage medium according to claim 21, wherein the determining a recommended vehicle speed of the target road segment based on the trajectory speed curve, comprises:
acquiring a maximum speed difference value between adjacent trajectory points in the trajectory speed curve;
if the maximum speed difference value is greater than a preset speed difference value threshold, performing segmentation processing on the trajectory speed curve to obtain a plurality of trajectory speed curve segments;
performing statistics on the speeds of the trajectory points in the plurality of historical traveling trajectories to determine a speed limit verification value of the target road segment; and
verifying the plurality of trajectory speed curve segments by utilizing the speed limit verification value, and determining the recommended vehicle speed of the target road segment based on a verification result.

23. The storage medium according to claim 21, wherein the determining a reference traveling trajectory based on the positions and speeds of the trajectory points in the plurality of historical traveling trajectories, comprises:
determining trajectory scores of the plurality of historical traveling trajectories based on trajectory time attenuation coefficients, trajectory direction change rates and trajectory speed change rates of the plurality of historical traveling trajectories; and
determining a historical traveling trajectory with the highest score as the reference traveling trajectory.

24. An electronic device, comprising:
a processor; and
a memory for storing processor-executable instructions;
wherein the processor is configured for reading the executable instructions from the memory and executing the instructions to implement the following:
based on historical traveling trajectory information of at least one vehicle on a target road segment, determining a plurality of historical driving-in trajectory points of a driving-in section of the target road segment, and determining a plurality of historical driving-out trajectory points of a driving-out section of the target road segment;
determining a driving-in section intersection point of the target road segment based on the plurality of historical driving-in trajectory points, and determining a driving-out section intersection point of the target road segment based on the plurality of historical driving-out trajectory points; and
determining a recommended traveling trajectory of the target road segment based on the driving-in section intersection point and the driving-out section intersection point.

25. The device according to claim 24, wherein the determining a driving-in section intersection point of the target road segment based on the plurality of historical driving-in trajectory points, and determining a driving-out section intersection point of the target road segment based on the plurality of historical driving-out trajectory points, comprises:
performing a first clustering on the plurality of historical driving-in trajectory points to determine the driving-in section intersection point; and
performing a second clustering on the plurality of historical driving-out trajectory points to determine the driving-out section intersection point.

26. The device according to claim 24, wherein the determining a recommended traveling trajectory of the target road segment based on the driving-in section intersection point and the driving-out section intersection point, comprises:
determining an associated historical traveling trajectory associated with the driving-in section intersection point and the driving-out section intersection point from the historical traveling trajectory information;
performing interpolation clustering on trajectory points of the associated historical traveling trajectory to determine at least one interpolated trajectory point; and
determining the recommended traveling trajectory based on the driving-in section intersection point, a trajectory point in the associated historical traveling trajectory, the at least one interpolated trajectory point, and the driving-out section intersection point.

27. The device according to claim 24, further comprising:
determining a plurality of historical traveling trajectories of the target road segment from the historical traveling trajectory information, and determining positions and speeds of trajectory points in the plurality of historical traveling trajectories;
determining a reference traveling trajectory based on the position and speed of the trajectory points in the plurality of historical traveling trajectories, wherein the reference traveling trajectory is one of the plurality of historical traveling trajectories;
performing aggregative filtering on positions and speeds of trajectory points in the reference traveling trajectory based on the positions and speeds of the trajectory points in the plurality of historical traveling trajectories to determine a trajectory speed curve of the target road segment; and
determining a recommended vehicle speed of the target road segment based on the trajectory speed curve.

28. The device according to claim 27, wherein the determining a recommended vehicle speed of the target road segment based on the trajectory speed curve, comprises:
acquiring a maximum speed difference value between adjacent trajectory points in the trajectory speed curve;
if the maximum speed difference value is greater than a preset speed difference value threshold, performing segmentation processing on the trajectory speed curve to obtain a plurality of trajectory speed curve segments;
performing statistics on the speeds of the trajectory points in the plurality of historical traveling trajectories to determine a speed limit verification value of the target road segment; and
verifying the plurality of trajectory speed curve segments by utilizing the speed limit verification value, and determining the recommended vehicle speed of the target road segment based on a verification result.

29. The device according to claim 27, wherein the determining a reference traveling trajectory based on the positions and speeds of the trajectory points in the plurality of historical traveling trajectories, comprises:
determining trajectory scores of the plurality of historical traveling trajectories based on trajectory time attenuation coefficients, trajectory direction change rates and trajectory speed change rates of the plurality of historical traveling trajectories; and
determining a historical traveling trajectory with the highest score as the reference traveling trajectory.

30. The device according to claim 24, further comprising:
acquiring a target lane in which a historical traveling trajectory does not exist in the target road segment;
determining a traffic path of the target lane based on a lane topological relationship of the target road segment; and
determining a recommended vehicle speed of the target lane based on at least one of a road type of the target lane, the traffic path of the target lane, and a vehicle speed signboard within a preset distance range of the target lane.
